(19) United States
(12) Patent Application Publication
(10) Pub. No.: US 2014/0015790 A1
(43) Pub. Date: Jan. 16, 2014

(54) CAPACITIVE TOUCH CONTROL SENSOR

(71) Applicants: YU-CHOU YEH, TAOYUAN COUNTY (TW); JUI-MING NI, TAOYUAN COUNTY (TW); PING-HSU LAI, TAOYUAN COUNTY (TW); HSIAO-SHUN JAN, TAOYUAN COUNTY (TW); CHENG-HSIUNG WU, TAOYUAN COUNTY (TW)

(72) Inventors: YU-CHOU YEH, TAOYUAN COUNTY (TW); JUI-MING NI, TAOYUAN COUNTY (TW); PING-HSU LAI, TAOYUAN COUNTY (TW); HSIAO-SHUN JAN, TAOYUAN COUNTY (TW); CHENG-HSIUNG WU, TAOYUAN COUNTY (TW)

(73) Assignee: J TOUCH CORPORATION, TAOYUAN COUNTY (TW)

(21) Appl. No.: 13/546,846

(22) Filed: Jul. 11, 2012

(51) Int. Cl. G06F 3/044

(52) U.S. Cl. 345/174

(57) ABSTRACT

The present disclosure provides a capacitive touch control sensor, including a plurality of first and second electrodes, a plurality of first and second electrode wires. The first and second electrodes are aligned at predetermined interval. Each of the first electrode wires connects to one of the first electrodes while each of the second electrode wires connects to more than one of the second electrodes. The first and second electrodes are alternatively disposed so as to reduce manufacturing cost and achieve lower structural profile.

### BACKGROUND

1. Technical Field

The present disclosure relates to a capacitive touch control sensor; in particular, to a single-layered capacitive touch control sensor.

2. Description of Related Art

FIG. 1 shows a top view of a conventional capacitive touch control sensor 1 having a multilayered structure that requires multiple fabrication processes. In a first fabrication process, a plurality rows of first axial electrode blocks 10, a plurality rows of first axial wires 11, and a plurality rows of separately and adjacently arranged second axial electrode blocks 12 are disposed on a substrate surface of the capacitive touch control sensor 1. The first axial wire 11 interconnects each row of the first axial electrode blocks 10 along a first axial direction, and the second axial electrode blocks 12 are separately interposed between each two adjacent rows of the first axial electrode bocks 10 on either side of the first axial wire 11, respectively. In a subsequent second fabrication process, an insulation layer 15 disposed on top of the interconnecting portion of the first axial wire 11 between each two adjacent first axial electrode blocks 10. Then, in a third fabrication process, a plurality of metallic second axial wires 13 is disposed on top of the insulation layers 15 to interconnect each column of the second axial electrode blocks 12 along a second axial direction. The insulation layer 15 sandwiched between the first axial wire 11 and the second axial wire 13 provides electrical insulation that keeps the first and the second axial wires from shorting, thus constituting a touch control circuit pattern. As can be seen, the manufacture process of the conventional multilayer capacitive touch control sensor 1 is complex and the production cost is high. Furthermore, the first electrode wires 14 and the second electrode wires 16 respectively interconnecting the first and second axial electrode blocks 10, 12 are made of visibly non-transparent metal materials which occupy part of the touch control region, resulting in a smaller display area on the touch screen.

### SUMMARY

The present disclosure provides a capacitive touch control sensor arrangement capable of overcoming existing issues in manufacturing complexity. The capacitive touch control sensor provides lower manufacturing cost and lighter product volume. Also, the capacitive touch control sensor arrangement provides increased touch sensing area, therefore elevates the sensor precision level. Furthermore, the arrangement of the first and second electrodes results in a relatively larger screen on the electronic products.

According to one exemplary embodiment of the present disclosure, a capacitive touch control sensor is provided, which includes a plurality of first electrodes, a plurality of first electrode wires, a plurality of second electrodes and a plurality of second electrode wires. The plurality of first electrodes is disposed at predetermined gaps, wherein each of the first electrode wires connects to one of the first electrode. The plurality of second electrodes is aligned at predetermined gaps, wherein each of the second electrode wires connects to more than one of the second electrodes in a column. The pluralities of first and second electrodes are substantial Y-shaped, which are disposed alternatively.

The present disclosure comprehends the following features:

The capacitive touch control sensor is single-layered and the first and second electrodes as well as the first and second electrode wires can be disposed in a single manufacturing process instead of the conventional complex, multiple procedure. Hence the present disclosure is lower in manufacturing cost and lighter in volume.

In the present disclosure, the first and second electrodes are substantially in the shape of “Y”. Also, the first and second electrodes have slanting extensions, the wing portions and the forth parts. Furthermore, the first and second electrode wires are arranged in a non-linear pattern. Compared to the conventional linear arrangement, the present disclosure can increase the touch sensing area, thus increasing in the sensor precision level as well as the sensor linearity.

The first and second electrodes and the first and second electrode wires are made of visibly transparent conductive material, which does not occupy additional display regions therefore increasing the touch sensing area on the final product.

In order to further understand the present disclosure, the following embodiments are provided along with illustrations to facilitate the appreciation of the present disclosure; however, the appended drawings are merely provided for reference and illustration, without any intention to be used for limiting present disclosure.

### BRIEF DESCRIPTION OF THE DRAWINGS

FIG. 1 shows a top view of a conventional capacitive touch control sensor.

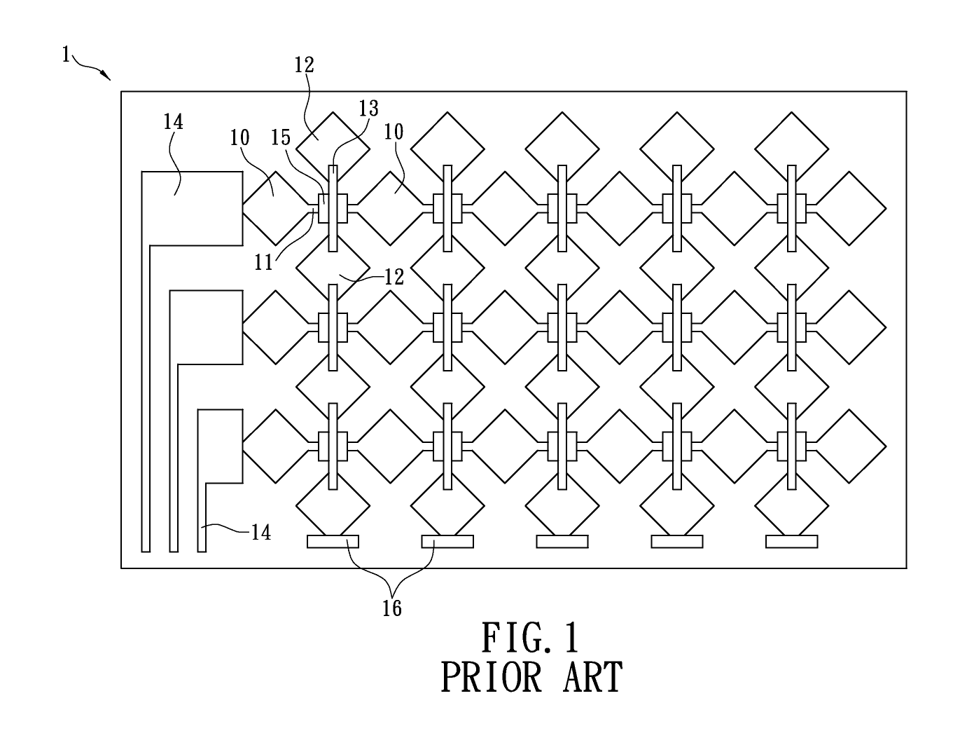

FIG. 2 shows a top view of a capacitive touch control sensor in accordance with one embodiment of the present disclosure.

FIG. 3 shows a top view of a capacitive touch control sensor arrangement in accordance with another embodiment of the present disclosure.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

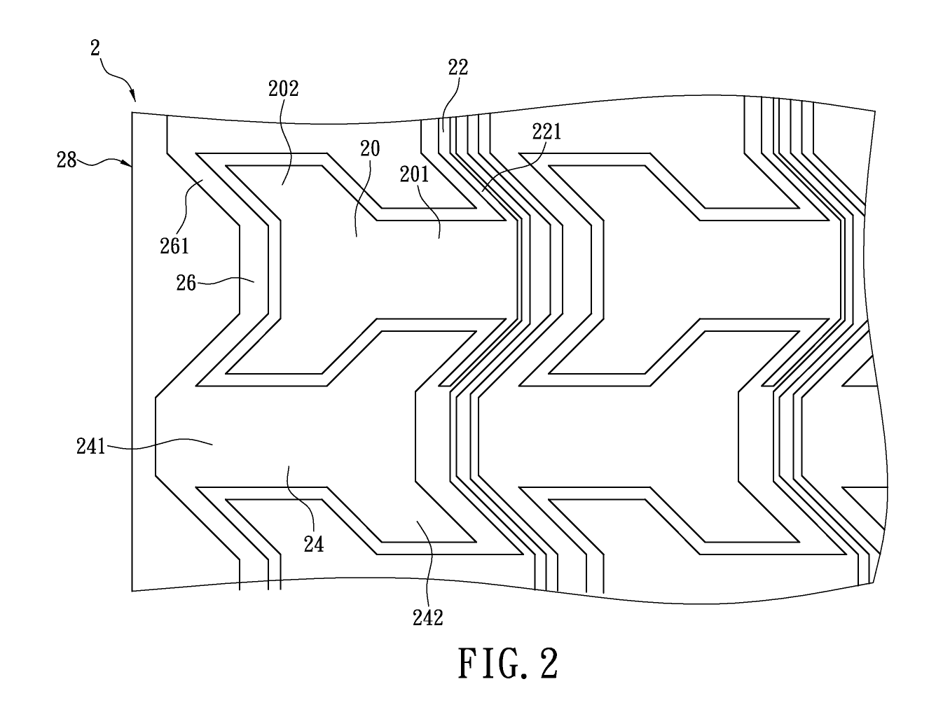

FIG. 2 shows a perspective view of an embodiment of a capacitive touch control sensor. The capacitive touch control sensor 2 includes a plurality of first electrodes 20, a plurality of first electrodes wire 22, a plurality of second electrodes 24 and a plurality of second electrode wires 26. The first and second electrodes 20, 24 together with the first and second electrode wires 22, 26 are made of a visibly transparent conductive material. The visibly transparent conductive material can be selected from the following: indium tin oxide (ITO), indium zinc oxide, aluminum doped zinc oxide, nanosilver, nanocopper, conductive polymer, carbon nanotube, graphene, silver bromide (AgBr), or indium gallium zinc oxide (IGZO).

The capacitive touch control sensor can further comprise a transparent substrate 28 hosting the first and second electrodes 20, 24 and the first and second electrode wires 22, 26 on the surface. Suitable material for the transparent substrate may be selected from the following: glasses, polycarbonate (PC), polyester (PET), poly (methyl methacrylate) (PMMA), cyclic olefin copolymer (COC), and the combination thereof.

As shown in FIG. 2, the plurality of first electrodes 20 is aligned at predetermined gap and in the preferable shape of substantial “Y”. Each of the first electrodes 20 comprises a root portion 201 and two wing portions 202. The root portion 201 can be in the shape of rectangle extending along a first axis. The two wing portions 202 can be in the shape of diamond flanking the root portion 201 in a slanting angle. Also, each of the first electrode wires 22 connects to one of the first electrodes 20.

Also shown in FIG. 2, the plurality of second electrodes 24 is aligned at predetermined gap and disposed alternatively against the plurality of the first electrodes 20. In the embodiment, the preferable shape of the second electrodes is substantial “Y”. Each of the second electrodes 24 comprises a root portion 241 and two wing portions 242. The root portion 241 can be in the shape of rectangle extending along the first axis. The two wing portions 242 can be in the shape of diamond flanking the root portion in a slanting angle. Moreover, each of the second electrode wires 26 connects to more than one of the second electrodes 24 in a column. The first and second electrode wires 22, 26 are slightly bent according to the outline of the first and the second electrodes 20, 24, hence forming a plurality of sinuous section 221 and 261.

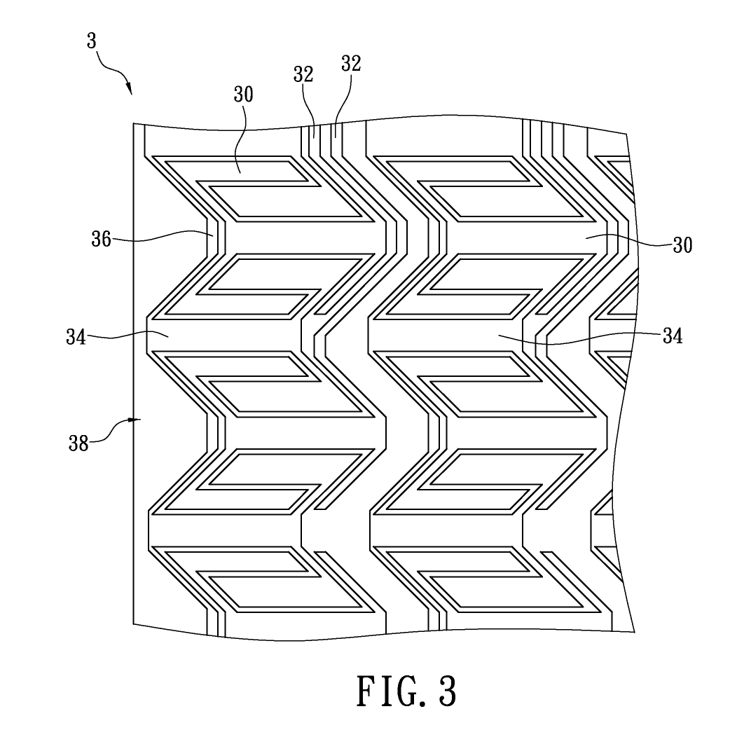

FIG. 3 shows another embodiment of the present disclosure. The difference between FIG. 2 and FIG. 3 lies on the patterns of the electrodes. The capacitive touch control sensor 3 includes a plurality of first electrodes 30, a plurality of first electrode wires 32, a plurality of second electrodes 34 and a plurality of second electrode wires 36. The capacitive touch control sensor 3 can further comprise a transparent substrate 38 and thus the first and second electrodes 30, 34 and the first and second electrode wires 32, 36 can be arranged on the transparent substrate 38.

As shown in FIG. 3, the plurality of first electrodes 30 is disposed at predetermined gap and the first electrodes 30 are substantially M-shaped. The shape of the second electrodes 34 is identical to that of the first electrodes 30. Also, the pluralities of first and second electrodes are disposed alternatively.

FIG. 2 only serves as an illustration example and the instant disclosure is not limited thereby. Firstly, the capacitive touch control sensor 2 is single-layered and the first and second electrodes 20, 24 as well as the first and second electrode wires 22, 26 can be constituted in a single manufacturing process instead of the conventional multiple complex procedure. Thus the present disclosure provides a lower manufacturing cost and lighter product volume.

Secondly, the first and second electrodes 20, 24 are in a substantial Y-shape. The first and second electrodes 20, 24 include the inclined extensions, the wing portion 202 and the wing portion 242. Accordingly, the first and second electrode wires 22, 26 are arranged non-linearly. In comparison to the conventional linear routing, the present disclosure increases the touch sensing area resulting in an increase in sensor precision and a refinement of sensor linearity.

Thirdly, the first and second electrode wires 22, 26 are made of the transparent conductive materials hence resulting in the touch screen on the electronic products being relatively larger.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A capacitive touch control sensor, comprising:
a plurality of first electrodes aligned in a plurality of rows with predetermined gaps arranged there-between;
a plurality of first electrode wires, wherein each of the first electrode wires connects one of the first electrodes;
a plurality of second electrodes aligned in a plurality of columns with predetermined gaps arranged there-between; and
a plurality of second electrode wires, wherein each of the second electrode wires connects more than one of the second electrodes in a same column,
wherein the first and second electrodes are coplanarly alternatively disposed.

2. The capacitive touch control sensor according to claim 1, wherein each of the first electrodes is substantially Y-shaped.

3. The capacitive touch control sensor according to claim 1, wherein each of the first electrodes includes a root portion extending in a first axis and a pair of wing portions oppositely and slantingly extending away from the root portion.

4. The capacitive touch control sensor according to claim 1, wherein each of the second electrodes is substantially Y-shaped.

5. The capacitive touch control sensor according to claim 1, wherein each of the second electrodes includes a root portion extending in the first direction and a pair of wing portions oppositely and slantingly extending away from the root portion.

6. The capacitive touch control sensor according to claim 1, wherein each of the first and second electrode wires comprises a plurality of sinuous sections.

7. The capacitive touch control sensor according to claim 1, wherein the first and second electrodes and the first and second electrode wires are made of a transparent conductive material.

8. The capacitive touch control sensor according to claim 1, further comprising a transparent substrate, wherein the first and second electrodes and the first and second electrode wires are disposed on a surface of the transparent substrate.

9. The capacitive touch control sensor according to claim 1, wherein each of the first electrodes is substantially M-shaped.

10. The capacitive touch control sensor according to claim 1, wherein each of the second electrodes is substantially M-shaped.
